(19) United States
(12) Patent Application Publication
(10) Pub. No.: US 2015/0105529 A1
(43) Pub. Date: Apr. 16, 2015

(54) Process For Preparing Silicone Resins

(71) Applicant: Dow Corning Corporation, Midland, MI (US)

(72) Inventors: Robert Fosdick, Midland, MI (US); Gary Wieber, Midland, MI (US)

(73) Assignee: Dow Corning Corporation, Midland, MI (US)

(21) Appl. No.: 14/400,050

(22) PCT Filed: May 22, 2013
(86) PCT No.: PCT/US13/42191

§ 371 Date: Nov. 10, 2014

Related U.S. Application Data
(60) Provisional application No. 61/650,650, filed on May 23, 2012.

(51) Int. Cl. C08G 77/34

(52) U.S. Cl. CPC C08G 77/34
USPC 528/12; 528/39

(57) ABSTRACT

A process is disclosed for preparing silicone resins having improved product purity. The process involves flowing a first liquid containing a silicone resin and an impurity through a fiber bundle, wherein the first liquid and second liquid are substantially immiscible.

### BACKGROUND

Silicone resins are widely used in a variety of significant commercial products. In particular, silicone MQ resins are used extensively in release coatings, pressure sensitive adhesives, electronic coatings, personal and household care products, to list just a few of their commercial applications

Due to their commercial significance, there have been several attempts to improve the processes for their preparation in a large scale manufacture setting.

There remains a need to identify further improvements in the processes for the preparation of silicone resins in a large scale manufacture setting. In particular, there is a need to identify processes that provide silicone resins having higher purity with less contaminants.

### BRIEF SUMMARY

The present inventors have discovered a process for preparing silicone resins having improved product purity. The process involves flowing a first liquid containing a silicone resin and an impurity through a fiber bundle, wherein the first liquid and second liquid are substantially immiscible.

### BRIEF DESCRIPTION OF THE DRAWINGS

FIG. 1 is a diagram of an apparatus for removing an impurity from a siloxane resin according to the present invention.

### DETAILED DESCRIPTION

The present disclosure relates to a process for preparing a silicone resin comprising:
I) polymerizing an alkali metal silicate in an acidic aqueous medium to form a silica hydrosol,
II) reacting the silica hydrosol with an organosilicon capping compound in a mixture containing an organic or siloxane solvent to form a silicone resin,
III) optionally, allowing the mixture from step II to separate into an aqueous phase and an organic phase containing the silicone resin,
IV) further processing the organic phase containing the silicone resin to remove an impurity by;
   i) flowing a first liquid through a fiber bundle comprising a plurality of fibers extending lengthwise in a conduit, wherein the bundle has an upstream end and a downstream end, and the first liquid flows in a direction from the upstream end of the bundle to the downstream end; and
   ii) while continuing (i), flowing a second liquid comprising the organic phase containing the silicone resin and an impurity through the fiber bundle in a direction from the upstream end of the bundle to the downstream end of the bundle to effect transfer of at least a portion of the impurity from the second liquid to the first liquid, wherein the first liquid and the second liquid are substantially immiscible.

The present process provides a method for producing silicone resins. As used herein “silicone resins” refer to organopolysiloxanes containing T or Q siloxy units. Organopolysiloxanes are polymers containing siloxy units independently selected from (R₃SiO_{1/2}), (R₂SiO_{2/2}), (RSiO_{3/2}), or (SiO_{4/2}) siloxy units, where R may be any organic group or hydrogen. These siloxy units are commonly referred to as M, D, T, and Q units respectively. These siloxy units can be combined in various manners to form cyclic, linear, or branched structures. The chemical and physical properties of the resulting polymeric structures vary depending on the number and type of siloxy units in the organopolysiloxane. “Resin” organopolysiloxanes generally result when a portion of the siloxy units used to prepare the organopolysiloxane are selected from T or Q siloxy units. In one embodiment, the present disclosure provides a process for making “silicone MQ resins”, in which the organopolysiloxane produced consists essentially of M and Q siloxy units.

### Step I) Polymerizing Alkali Metal Silicate in an Acidic Aqueous Medium to Form a Silica Hydrosol

The first step of the present process involves polymerizing an alkali metal silicate in an acidic aqueous medium to form a silica hydrosol. The polymerization reaction effected in step I involves condensation of the alkali metal silicate to form a silica hydrosol. The polymerization is catalyzed by acids, and therefore the reaction is conducted in an acidic aqueous medium.

The amount and type of the alkali metal silicate used in the acidic aqueous medium may vary. The alkali metal may be any of the metal from the first column of the periodic such as lithium, sodium, potassium, etc. However, typically the alkali metal is sodium. Typically, an aqueous solution of the sodium silicate is first prepared having a SiO₂ content ranging from 5 wt % to 75 wt %, alternatively from 5 wt % to 50 wt %, alternatively from 5 wt % to 30 wt %, alternatively from 5 wt % to 25 wt %, or alternatively from 10 wt % to 20 wt %.

Aqueous solutions of sodium silicates are available commercially, and may be used directly in the present process. Often, they are referred to as “water glass” solutions.

An acid is combined with the aqueous solution of sodium silicate to provide the acidic medium for the step I reaction. Suitable acids include both inorganic acids, such as for example, hydrochloric acid, nitric acid, hydrobromic acid, hydrogen iodide, sulfuric acid, phosphoric acid, sulfonic acid, and carbonic acid and organic acids, such as, for example, acetic acid, propionic acid, formic acid, benzoic acid, salicylic acid, adipic acid, dicarboxylic acids, oleic acid, palmitic acid, stearic acid, and phenylstearic acid, as well as mixtures of any of the above. Typically, the acid comprises one or more of hydrochloric acid, sulfuric acid, nitric acid, phosphoric acid, sulfonic acid, hydrobromic acid and hydrogen iodide. In one embodiment, the acid comprises hydrochloric acid.

The acid is typically combined with the aqueous sodium silicate solution as an aqueous solution having an acid concentration of from 5 wt % to 99 wt %, alternatively from 5 wt % to 40 wt %, or alternatively from 15 wt % to 40 wt %.

A sufficient amount of the acidic solution is added to the aqueous sodium silicate solution to prepare an acidic medium having a pH≦3, alternatively having a pH≦2, alternatively having a pH≦1. Typically, the amount of acidic solution is sufficient to provide these pH values after the polymerization reaction of step I.

Typically, upon combining the sodium silicate solution and acid solution, the polymerization reaction will proceed.

The polymerization reaction of step I is typically carried out at a temperature ranging from −5° C. to 75° C., alternatively from 0° C. to 40° C., or alternatively from 5° C. to 30° C.

The polymerization reaction of step I may be effected using mixing techniques that may be considered as batch, semi-batch, continuous, semi-continuous mixing, or any combination of these mixing techniques.

The polymerization reaction of step I may be effected in a continuous process, such as described in EP 1 113 036 in which reactants are continuously supplied to a reactor and products are continuously removed from the reactor. EP 1 113 036 is incorporated herein by reference for its teaching of continuous mixing techniques useful in step I. In particular, EP 1 113 036 teaches metered streams of sodium silicate and a dilute acid are continuously supplied to a reactor. The reactor may be any type of reactor consisting of one or more of a series of mixing stages, such as, for example, a plug flow static mixer reactor, a packed plug flow reactor, a Scheibel type plug flow column or a mix loop reactor. Scheibel type plug flow columns are preferred in the teachings of EP 1 113 036.

The mixing of the silicate solution and aqueous acidic solution may be effected by continuous dynamic mixing, as described in U.S. Pat. No. 7,951,895, which is herein incorporated by reference for its teaching of useful mixing techniques for step I. In particular, U.S. Pat. No. 7,951,895 teaches that at least one fluid (1) comprising the sodium silicate (B) in an aqueous phase and at least one fluid (2) comprising the acid (C) are mixed by continuous dynamic mixing, the streams meeting each other at a single point to form a mixture (3) using at least one intensive mixing tool (M) dissipating a power density ∈ greater than 10 kW/m³, preferably greater than 20 kW/m³ and more preferably, still 20 kW/m³<∈<106 kW/m³. Examples of an intensive mixing tool (M) include tangential-jet mixers, mixers that operate by impact of free jets (that is to say without contact of the jets with the walls of the mixer) and rotor-stator type mixers. One intensive mixing tool (M) may be a tangential-jet mixer. In this case, the flow rate of each reactant is divided into two streams which are introduced into the mixer in a diametrically opposed, but slightly offset manner. The injection channels of the reactants have a small diameter (between 0.5 and 5 mm) over a length of a few millimeters for the inlets, the outlet channel has a diameter between 3 and 10 mm.

In one embodiment, a flowing stream of an aqueous sodium silicate solution is rapidly mixed in a continuous manner with an aqueous hydrochloric acid solution flowing at a rate sufficient to reduce the pH of the resulting solution to below pH 2, or alternatively near pH=0. In this embodiment, the aqueous sodium silicate solution has a SiO₂ content ranging from 5 wt % to 75 wt %, alternatively from 5 wt % to 25 wt %, alternatively from 10 wt % to 20 wt %. Also in this embodiment, the aqueous hydrochloric acid solution aqueous solution has an acid concentration of from 5 wt % to 99 wt %, alternatively from 5 wt % to 35 wt %, or alternatively from 15 wt % to 30 wt %.

Before combining, the aqueous sodium silicate solution and hydrochloric acid solutions may be cooled to a temperature ranging from 1° C. to 20° C.

The mixing rates of the combined sodium silicate solution and aqueous hydrochloric acid solution should be sufficient to minimize the amount of time the aqueous sodium silicate solution experiences local concentration regimes with pH 5-8, a range in which silicate solutions have minimum stability towards gelation.

The aqueous sodium silicate solution and aqueous hydrochloric acid solution may be combined in a closed loop reactor. Typically, the closed loop reactor will comprise a pipe having a diameter and length to provide a sufficient residence time and intensive mixing energy to ensure rapid mixing of the aqueous sodium silicate solution and hydrochloric acid solutions to provide the mixture with a pH of ≦2. Typically, residence times vary from 5 sec to 100 sec, alternatively from 5 sec to 30 sec.

Alternatively, the aqueous sodium silicate solution and aqueous hydrochloric acid solution may be combined in a continuous stirred tank reactor (CSTR).

The aqueous sodium silicate solution and aqueous hydrochloric acid solution may be provided to the closed loop reactor or CSTR as separate streams, and combined with further mixing within the reactor.

The temperature of the combined streams within the closed loop or CSTR may vary according to the temperature ranges discussed above, or alternatively may vary from 5 to 30° C.

The polymerization reaction of step I is allowed to proceed until a desired molecular weight of the silica hydrosol is achieved. For example, the polymerization may be allowed to proceed in the same mixing equipment as used to combine the sodium silicate solution and aqueous hydrochloric acid solution. Alternatively, the polymerization may be allowed to proceed in a separate unit after sufficient mixing of the aqueous sodium silicate solution and aqueous hydrochloric acid solution has occurred to reduce the pH of the resulting solution to below pH 2, or alternatively near pH=0. Thus, the polymerization reaction of step I may proceed in a continuous plug flow unit, or alternatively in a CSTR.

The polymerization reaction in step I is allowed to proceed until the desired molecular weight of the silica hydrosol is obtained. The desired molecular weight may be determined indirectly by monitoring the molecular weight of the resulting silicone resin produced by the process. The molecular weight of the resulting silicone resin may be readily assessed by any known analytical techniques, such as gel permeation chromatography (GPC). Thus, various process parameters such as mixing rates, concentrations of the aqueous acid and silicate solutions, flow rates, residence times, and temperatures may be adjusted in step I to provide the desired molecular weight of the silica hydrosol, and subsequently the silicone resin.

Once the desired silica hydrosol molecular weight is achieved, the polymerization reaction may be terminated by adding a “quencher” to the formed silica hydrosol. As used herein, a quencher is any compound added to the reaction mixture of step I to essentially inhibit polymerization of the silica hydrosol and thereby control the molecular weight of the products formed. The quencher may simply slow the polymerization reaction of step I sufficiently such that the increase in molecular weight of the silica hydrosol is negligible or insignificant. Alternatively, the quencher may completely terminate the polymerization reaction so no change in molecular weight occurs. The quencher may be a polar water soluble organic compound capable of inhibiting further polymerization of the hydrosol. Suitable quenchers may be for example organic alcohols such as; methanol, ethanol, n-propanol, isopropanol, n-butanol, isobutanol. Suitable quenchers may also be glycols such as; ethylene glycol and propylene glycol; ketones such as for example, acetone and methyl ethyl ketone, as well as mixtures of all of the above. Suitable quenchers may also include carboxylic acids such as acetic acid and sulfoxides such as dimethylsulfoxide (DMSO). The quencher may be a water-soluble organic alcohol or glycol or mixture thereof. Typically, the quencher may be isopropanol, methanol, ethanol, or mixtures thereof.

The quencher may be added at the conclusion of step I (i.e. when the desired molecular weight of the silica hydrosol is obtained), or alternatively the quencher may be added simultaneous in the capping reaction, detailed in step II as follows.

Step II) Reacting the Silica Hydrosol with an Organosilicon Capping Compound in a Mixture Containing an Organic or Siloxane Solvent to Form a Silicone Resin

The second step of the present process involves reacting the silica hydrosol from step I with an organosilicon capping compound in a mixture containing an organic or siloxane solvent to form a silicone resin. The reaction effected in step II may be considered as a “Lentz-type” capping (Lentz, Charles W., Inorganic Chemistry, 3 (4), 1964, 574-579) of the silanol moieties on the silica hydrosol.

Suitable organosilicon capping compounds include halo, hydroxyl, alkoxy or triorganosiloxy functional silicon compounds. The organosilicon capping compound may be selected from those having the formula

R¹ₙSiX₍₄₋ₙ₎
wherein R¹ is independently a C₁-C₂₀ hydrocarbyl group or hydrogen,
   X is a halogen atom, —OR², or —OSiR¹₃,
      where R² is a C₁-C₆ alkyl group or hydrogen,
   n is 1, 2, or 3, alternatively n is 2 or 3, alternatively n is 3.
      In the above formula, R¹ is independently a C₁-C₂₀ hydrocarbyl group or hydrogen. The hydrocarbon group may independently be an alkyl, aryl, or alkylaryl group. As used herein, hydrocarbyl also includes halogen substituted hydrocarbyls. R¹ may be a C₁ to C₂₀ aryl group, such as phenyl, naphthyl, anthryl group. Alternatively R¹ may be phenyl. R¹ may be a C₁ to C₂₀ alkyl group, alternatively R¹ may be a C₁ to C₁₂ alkyl group. Alternatively R¹ may be a C₁ to C₆ alkyl group such as methyl, ethyl, propyl, butyl, pentyl, or hexyl. Alternatively R¹ may be methyl. Also in the above formula, X is a halogen atom such as chlorine. X may also be a group of the formula —OR² where R² is a C₁-C₆ alkyl group or a hydrogen atom, alternatively X is a methyl group. X may also be a group of the formula —OSiR¹₃ where R¹ is as defined above. X may also be any combination of halogen atoms, —OR², or —OSiR¹₃ groups.

In one embodiment, the capping agent is selected from trimethylchlorosilane, hexamethyldisiloxane, or a mixture thereof.

The silica hydrosol reaction product from step I and the organosilicon capping compound are reacted in a mixture containing an organic or siloxane solvent. The order of addition of the silica hydrosol, the organosilicon capping agent, and the solvent may vary and is not critical. The solvent may be added to the silica hydrosol upon completion of step I.

Suitable solvents for use in the capping reaction of step II include water soluble alcohols like methanol, ethanol, or isopropanol.

Suitable organic or siloxane solvents for use in the capping reaction of step II also include those solvents in which the desired silicone resin product is soluble. Representative examples include; hexamethyldisiloxane, toluene, xylene, linear and branched hydrocarbons, such as heptane, octane and isododecane, as well as mixtures thereof.

In some instances, the quencher may be considered to comprise the step II solvent. For example, a water-soluble organic alcohol such as isopropanol may be considered as a solvent in step II, while also functioning as a quencher for the polymerization reaction of step I.

In other instances, the capping compound may be considered to comprise the step II solvent. For example, hexamethyldisiloxane may be considered as an organosilicon capping agent while simultaneously acting as a solvent for the step II reaction.

The amount of capping compound suitable for use in the present invention varies with the degree of capping desired, the specific capping compound selected, and the amount of silica hydrosol formed in step I reaction. Typically, the amount of capping compound added in step II is added in sufficient quantities to provide from

0.1 mole to 4 mole of M siloxy units,
alternatively from 0.5 mole to 3.5 mole of M siloxy units,
   or alternatively from 0.6 mole to 1.0 mole, of M siloxy units per mole
SiO₂ units contained in the hydrosol.

The capping reaction of step II may be effected using mixing techniques that may be considered as batch, semi-batch, continuous, semi-continuous mixing, or any combination of these mixing techniques.

The capping reaction of step II is typically carried out at a temperature ranging from 0° C. to 100° C., alternatively from 50° C. to 70° C.

The capping reaction of step II is typically carried out in an acidic medium having a pH≦2. The pH of the mixture in step II typically results from adding sufficient acid in step I to maintain the desired acidic pH in step II.

Step III) Optionally, Allowing the Mixture from Step II to Separate into an Aqueous Phase and an Organic Phase Containing the Silicone Resin

Step III is an optional step, and involves allowing the mixture from step II to separate into an aqueous phase and an organic phase containing the silicone resin. Capping the silica hydrosol provides the silicone resin, which should be soluble in the selected organic/siloxane solvent used in the step II capping reaction. The reaction mixture resulting from step II will contain an aqueous phase and organic/siloxane phase. These two phases may be separated before proceeding to step IV by using any known methods for separating aqueous and organic phases, such as decanting. The decanting phase may be performed in batch or, alternatively in a substantially continuous manner.

The residence time and temperature of the separation in step III may be varied depending on the silicone resin produced. Separation can be performed by any known method, including both batch methods and continuous methods. Typically, the temperature of the separation in step III is between 40° C. to 100° C.

### Step IV) Further Processing the Organic Phase Containing the Silicone Resin to Remove an Impurity

Step IV) involves further processing the organic phase containing the silicone resin to remove impurities. More specifically, this step involves;
i) flowing a first liquid through a fiber bundle comprising a plurality of fibers extending lengthwise in a conduit, wherein the bundle has an upstream end and a downstream end, and the first liquid flows in a direction from the upstream end of the bundle to the downstream end; and
ii) while continuing (i), flowing a second liquid comprising the organic phase containing the silicone resin and an impurity through the fiber bundle in a direction from the upstream end of the bundle to the downstream end of the bundle to effect transfer of at least a portion of the impurity from the second liquid to the first liquid, wherein the first liquid and the second liquid are substantially immiscible.

The first liquid typically comprises a polar solvent, the aqueous phase from steps II/III of the present process, or combinations thereof. In other words, the first liquid may be the aqueous phase of steps II or III. Alternatively, additional polar solvents may be added to the aqueous phase of steps II or III.

The polar solvent may be any polar protic or polar aprotic solvent. As used herein, “polar” means having a dielectric constant of at least 15 at 20° C. Examples of polar solvents include, but are not limited to, water; water solutions, including acid and base (e.g., KOH or NaOH) solutions; alcohols, including ethanol, propanol, isopropanol, and butanol; phenols; amines, including polyamines, ethanolamines, and polyethanolamines; carboxylic acids; dimethyl sulfoxide; ketones such as acetone; and ionic liquids, including 1-allyl-3-methylimidazolium chloride, 1-ethyl-3-methylimidazolium tetrafluoroborate, 1,2-dimethyl-3-n-propylimidazolium tetrafluoroborate, 1,2-dimethyl-2-n-butylimidazolium tetrafluoroborate, and 1,2-dimethyl-3-n-butylimidazolium hexafluorophosphate. In one embodiment, the first liquid comprises water. The first liquid may be a mixture of polar solvents.

The fibers in the fiber bundle are selected to be preferentially wetted by the first liquid versus the second liquid, the latter described below. The fibers typically do not also add contaminates to the siloxane and typically are able to withstand the process to prevent frequent replacement.

Examples of fibers include, but are not limited to, fibers comprising cotton, jute, silk, treated minerals, untreated minerals, metals, metal alloys, treated carbon, untreated carbon, polymers, and polymer blends. Suitable treated or untreated mineral fibers include, but are not limited to, fibers of glass, asbestos, ceramics, and combinations thereof. Suitable metal fibers include, but are not limited to, fibers of iron, steel, nickel, copper, brass, lead, tin, zinc, cobalt, titanium, tungsten, nichrome, silver, aluminum, magnesium, and alloys thereof. Suitable polymer fibers include, but are not limited to, fibers of hydrophilic polymers, polar polymers, hydrophilic copolymers, polar copolymers, and combinations thereof, such as polysaccharides, polypeptides, polyacrylic acid, polymethacrylic acid, functionalized polystyrene (including sulfonated polystyrene and aminated polystyrene), nylon, polybenzimidazole, polyvinylidenedinitrile, polyvinylidene chloride, polyphenylene sulfide, polymelamine, polyvinyl chloride, co-polyethylene-acrylic acid and ethylene-vinyl alcohol copolymers. In one embodiment, the fibers comprise glass or steel fibers.

The diameter of the fibers forming the fiber bundle is typically from 1 to 100 μm, alternatively from 5 to 25 μm, alternatively from 8 to 12 μm.

Combinations of fibers may be employed. The fibers may be made by methods known in the art. Many of these fibers are available commercially.

The fiber bundle may be formed in the conduit, described below, by methods known in the art. For example, a group of the fibers may be hooked at the middle with a wire and pulled into the conduit using the wire.

The conduit is typically cylindrically shaped and comprised of a non-reactive material, such as stainless steel or Teflon. The conduit is typically part of a mass transfer apparatus comprising fibers. Mass transfer apparatuses comprising fibers are known in the art. For example, mass transfer apparatuses have been described in U.S. Pat. No. 3,977,829, U.S. Pat. No. 5,997,731, and U.S. Pat. No. 7,618,544.

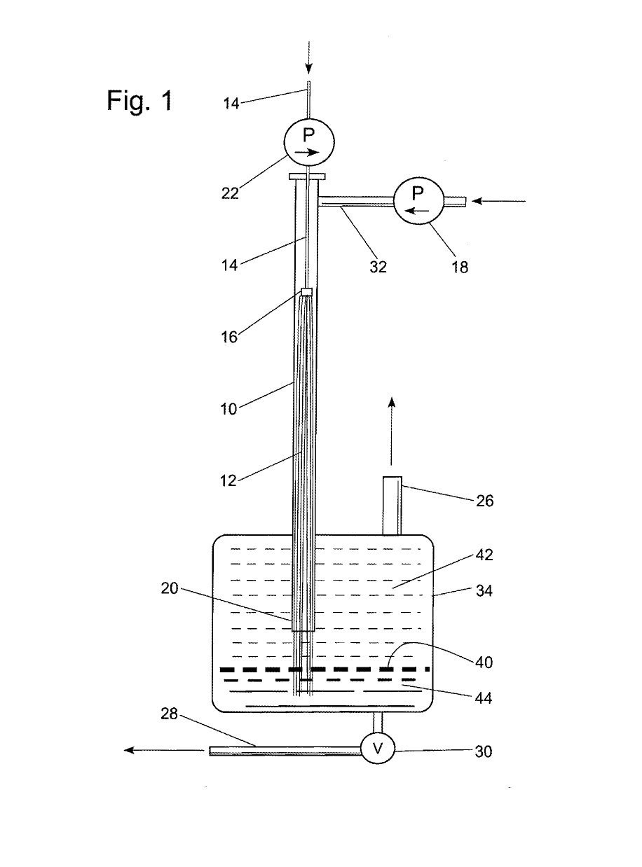

An apparatus comprising a conduit is depicted in FIG. 1; however, the invention is not intended to be limited to such apparatus. One skilled in the art will readily envision other acceptable design variations for the apparatus based on this description. In FIG. 1, conduit 10 has in it a fiber bundle 12 filling the conduit 10 for a portion of its length. The fiber bundle 12 is in contact with and extends into tube 14 at end 16. Tube 14 extends beyond the end of the conduit 10 and has metering pump 22 associated with it to pump a first liquid through tube 14 and onto the fiber bundle 12. Connected to conduit 10, upstream of the end 16 of tube 14, is an inlet pipe 32 having associated with it a metering pump 18. Pump 18 supplies a second liquid through inlet pipe 32 and into conduit 10, where it flows between fiber bundle 12. At the downstream end of the conduit 10 is a collection vessel 34 into which the downstream end 20 of conduit 10 and fiber bundle 12 may extend. The first and second liquids flow into collection vessel 34 and form layers 42 and 44. Fiber bundle 12 extends out of the downstream end 20 of conduit 10 into collection vessel 34 and first layer 44. Associated with an upper portion of collection vessel 34 is an outlet line 26 for top layer 42, and associated with a lower portion of collection vessel 34 is an outlet 28 for bottom layer 44. There is a metering valve 30 in outlet 28. In one embodiment (not shown), the apparatus is also equipped with means of controlling the temperature within the conduit. For example, the apparatus may be equipped with a heat exchanger or a heating jacket.

The temperature of the first liquid introduced in step i) is not critical and can vary from greater than the freezing point temperature to less than the boiling point temperature of the first liquid. For example, when the first liquid is water, the temperature is typically from greater than 0° C. to less than 100° C.; alternatively from 15 to 80° C.; alternatively from 15 to 60° C. at standard pressure.

The pressure at which the first liquid is introduced is typically atmospheric pressure or greater than atmospheric pressure. For example, the first liquid is typically introduced at a pressure from 0 to 1000 kilopascals gauge (kPag), alternatively from 0 to 800 kPag.

The viscosity is sufficient so that the first liquid flows through the fiber bundle. For example, a sufficient viscosity of the first liquid is typically from 0.1 to 500 cSt, alternatively from 0.1 to 100 cSt, alternatively from 0.1 to 50 cSt, alternatively from 0.1 to 10 cSt, at 25° C.

In step (ii), a second liquid, comprising the organic phase containing the silicone resin and an impurity is flowed through the fiber bundle, while continuing (i), in a direction from the upstream end of the bundle to the downstream end of the bundle to effect transfer of the impurity from the second liquid to the first liquid, wherein the first liquid and the second liquid are substantially immiscible.

The second liquid comprises the organic phase containing the silicone resin as produced in step II or III. In one embodiment, the second liquid is the organic phase containing the silicone resin resulting directly from step II or III. In another embodiment, the organic phase containing the silicone resin is first processed to remove certain components. For example, the organic phase may be “stripped” to remove water and/or organic solvents. Stripping of volatiles is well known in the art, and may be accomplished by any method. Generally, the product is heated to a temperature of from about 100° C. to about 250° C. The organic phase containing the silicone resin may be allowed to reflux, and subsequently, the volatiles are removed by any known method, such as, for example, vacuum distillation or by employing a nitrogen purge. Stripping reduces the volatiles content of the final product. The stripping process may be performed in batch, or in a substantially continuous manner. Furthermore, the alcohol and other volatile materials, such as, for example, water, solvents, silanes, removed in the stripping process may be recovered and recycled to the reactor in which alcohol is added to substantially inhibit the polymerization process.

The impurity is any material that is extractable from the second liquid by the first liquid. Examples of the impurity include, but are not limited to, acids, such as hydrogen chloride, hydrogen bromide, hydrogen iodide, acetic acid, and trifluoromethane sulfonic acid; salts, such as sodium chloride, potassium chloride, sodium bromide, potassium bromide, sodium trifluoroacetate, and potassium trifluoroacetate; ions, such as Cl⁻, Br⁻, Na⁺, and K⁺; and linear and cyclic siloxanes with a molecular weight less than 500 g/mole. The term “impurity” as used herein also includes combinations of any of these materials.

The concentration of the impurity in the second liquid is typically at least 3 parts per million by weight (ppmw), based on the weight of the impurity and the siloxane, alternatively from 10 to 10,000 parts per million by weight (ppmw), alternatively from 10 to 5000 ppmw, alternatively from 50 to 1500 ppmw, on the same basis.

In one embodiment, hydrogen chloride (HCl) is removed as the impurity from the second liquid containing the silicone resin. The efficiency of HCl removal may be defined as follows; HCl removal efficiency (%)=([HCl]_{b}−[HCl]ₐ)/[HCl]_{b})×100, where [HCl]_{b} is the hydrochloric acid concentration in the silicone resin composition (or second liquid) before treatment according to step IV of the present process; and [HCl]ₐ is the hydrochloric acid concentration in the silicone resin composition (or second liquid) after treatment according to step IV of the present process. In this embodiment, greater than 95% of the hydrogen chloride is removed from the silicone resin composition (or second liquid), alternatively greater than 97% of the hydrogen chloride is removed from the silicone resin composition (or second liquid), or alternatively greater than 99% of the hydrogen chloride is removed from the silicone resin composition (or second liquid).

The second liquid may further comprise an optional non-polar solvent that is miscible with the silicone resin. The non-polar solvent may be included to, for example, dilute a silicone resin of high viscosity or dissolve a solid silicone resin. For example, the second liquid may comprise at least 10% (w/w), alternatively at least 25% (w/w), alternatively from 40 to 90% (w/w), based on the combined weight of the non-polar solvent and the silicone resin.

Examples of non-polar solvents include, but are not limited to, aromatic solvents, such as xylene or toluene; aliphatic solvents, such as pentane, hexane, heptane, octane, isoalkanes or blends of isoalkanes, such as a blend of C9-C19 isoalkanes or and C12-C18 isoalkanes; and siloxanes, such as hexamethyldisiloxane. In one embodiment, the second liquid further comprises hexamethyldisiloxane.

The viscosity of the second liquid is sufficient for the second liquid to flow through the conduit. For example, the viscosity of the second liquid is typically less than 500 centistokes (cSt), alternatively from 0.1 to 500 cSt, alternatively from 0.1 to 100 cSt, alternatively from 0.1 to 50 cSt, alternatively from 0.1 to 10 cSt, at 25° C. The viscosity of the second liquid can be controlled by dissolving higher viscosity or solid silicone resin in a suitable non-polar solvent as described above.

The volumetric flow ratio of the second liquid to the first liquid is typically at least 0.1, alternatively from 0.1 to 20, alternatively from 1 to 4, alternatively about 3. As used herein, “volumetric flow ratio” means the ratio of the volumetric flow rate of the second liquid to that of the first liquid.

The temperature and pressure at which the second liquid is introduced is as described for the first liquid.

The second liquid is substantially immiscible with the first liquid. As used herein, “substantially immiscible” means that the second liquid will not dissolve uniformly in the first liquid, and the second liquid will form, with the first liquid two layers. The use of “substantially” is intended to include embodiments where the first or second liquid may have some slight miscibility.

The second liquid, together with the first liquid, has a residence time that is sufficient to remove at least a portion of the impurity from the second liquid. For example, a sufficient residence time is typically at least 5 s, alternatively from 5 s to 30 minutes; alternatively from 30 s to 15 min; alternatively from 1 min to 10 min. As used herein, “residence time” means the time for one conduit volume (i.e., the volume of liquid that can fill the conduit comprising the fiber bundles) of the first liquid and second liquid together to pass through the conduit containing fibers.

The first liquid and second liquid may be flowed into the conduit by gravity or a pump.

The process of the invention may further comprise iii) receiving the first liquid and the second liquid in a collection vessel, wherein the first liquid forms a first layer and the second liquid forms a second layer in the collection vessel.

The first layer is typically the bottom layer and comprises the polar solvent and the impurity removed from the second liquid. The second layer is typically the top layer and comprises the silicone resin from the second liquid. However, the position of the first layer and second layer in the collection vessel may be reversed.

The concentration of the impurity in the second layer is less than the concentration in the second liquid when initially introduced. For example, the concentration of the impurity in the second layer is typically from 0 to 50%, alternatively from 0.01 to 40%, alternatively from 0.01 to 30%, alternatively from 0.01 to 10%, of the initial concentration in the second liquid.

The collection vessel may be a gravity separator or settling tank or any other vessel that will allow for the collection and separation of the first and second liquids exiting the apparatus.

Step i) is typically conducted prior to, and during, step (ii). The collection of the first and second liquids in optional step iii) typically begins after step (i) and continues until the first liquid and second liquid cease to flow out of the conduit.

The process of the invention may further comprise iv) separating the first and second layer. The first and second layer may be separated by withdrawing the first layer and the second layer separately from the collection vessel. The first layer and second layer may be withdrawn from the collection vessel with the aid of a pump.

The process of the invention may also comprise feeding the silicone resin phase separated in step iv) to the same, or another, apparatus for the further removal of at least another portion of the impurity.

The present process is useful to prepare silicone MQ resins. In one embodiment, the silicone MQ resins are characterized as having: a M/Q ratio varying from 0.5 to 1.5, alternatively from 0.6 to 1.2, alternatively from 0.7 to 1.0; a molecular weight (M_{w}) ranging from 5,000 to 50,000 g/mole, alternatively from 10,000 to 30,000 g/mole, or alternatively from 15,000 to 25,000 g/mole; and a silanol (SiOH) content ranging from 0.5 wt % to 10.0 wt %, alternatively from 1 wt % to 8.0 wt %, or alternatively from 2 wt % to 6.0 wt %.

In a further embodiment, the present process is useful to prepare silicone MQ resins wherein greater than 95 wt %, alternatively, greater than 97 wt %, or alternatively greater than 99 wt % of residual HCl is removed from the silicone MQ resin composition.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention. All percentages are in wt. %. All measurements were conducted at 23° C. unless indicated otherwise.

List of abbreviations used in the examples.

| Abbreviation | Word |
|---|---|
| G | gram |
| Wt | weight |
| % | percent |
| Mol | mole |
| Hr | hour |
| ° C. | degrees Celsius |
| mL | milliliters |
| Cm | centimeter |
| DI | deionized |
| Mw | weight average molecular weight |
| cSt | centistokes |

### Example 1

This example illustrates the use of an apparatus according to FIG. 1 to treat a silicone resin composition to remove hydrochloric acid from the silicone resin composition. The silicone resin of this example was a silicone MQ resin prepared according to steps I, II, and III of the present process having an MQ ratio of 0.8, a molecular weight (M_{w}) of 21,000 g/mole, and a silanol content of 3%. The apparatus of this example comprised a 1.27 cm outer diameter, 40.64 cm long Teflon-FEP tube as the conduit containing Glass Wool Pyrex fibers (Catalog #32848-003, Van Waters and Rogers, Redmond, Wash.). The fibers were 8 μm in diameter, approximately 60.96 cm in length, packed tightly along the entire length of the conduit, and had approximately 10 cm extending out of the downstream end of the conduit into a separatory funnel. A 1.27 cm stainless steel tee was attached to the inlet end of the conduit and deionized water and silicone resin feed lines attached.

Water flow was introduced into the apparatus conduit at the upstream end of the Pyrex glass fibers as the first liquid. After the water flow was started, a second liquid comprising the silicone MQ resin and hexamethyldisiloxane (wherein the amounts of silicone MQ resin and hexamethyldisiloxane was such to provide the liquid with a viscosity of 5 cSt at 21° C.) containing HCl was introduced into the conduit at the upstream end of the fibers through the side inlet of the tee. The water first liquid and second liquid containing the silicone resin were collected in the separatory funnel at the downstream end of the fibers. Three experimental runs were performed varying the contact time and flow rates as summarized in Table 2. The DI water and siloxane streams exited the conduit as separate phases. No settling time was required in the separatory funnel as there was instantaneous separation of the silicone resin and water phases. Samples of the silicone resin stream prior to entering the conduit and from the collection vessel were titrated with potassium hydroxide using bromocresol purple indicator to determine the acid concentration. All testing was performed at 25° C.

TABLE 1
Treatment of silicone MQ resin and hexamethyldisiloxane composition
with water in an apparatus comprising glass fibers to remove HCl.

| | | | | | HCl |
|---|---|---|---|---|---|
| Water | Silicone | Flow rate | Fiber | Residence | removal |
| flow rate | flow rate | ratio sili- | content in | time | efficiency* |
| (g/mm) | (g/min) | cone:water | conduit | (min.) | (%) |
| 1.4 | 3.8 | 2.7:1 | 145,000 | 8 | 99.9 |
| 1.6 | 4 | 2.5:1 | 73,000 | 9 | 99.2 |
| 1 | 4 | 4:1 | 145,000 | 8 | 99.9 |

*HCl removal efficiency (%) = ([HCl]_{b} − [HCl]ₐ)/[HCl]_{b}) × 100, where [HCl]_{b} is the hydrochloric acid concentration in the silicone resin composition before treatment; and [HCl]ₐ is the hydrochloric acid concentration in the silicone resin composition after treatment.

### Example 2

The same apparatus, reactants and procedure were used as in example 1 except that the Teflon-FEP conduit measured only 14 cm in length, and 10 cm of the fibers extended out of the downstream end of the conduit and into the collection vessel. The parameters were varied as listed in Table 2.

TABLE 2
Treatment of the silicone MQ resin and hexamethyldisiloxane with
water in an apparatus comprising glass fibers to remove HCl.

| | | | | | HCl |
|---|---|---|---|---|---|
| Water | Silicone | flow rate | Fiber | Residence | removal |
| flow rate | flow rate | ratio sili- | content in | time | efficiency |
| (g/min) | (g/min) | cone:water | conduit | (min.) | (%) |
| 1.6 | 4.1 | 2.6:1 | 145,000 | 4.5 | 97.9 |
| 1.4 | 3.7 | 2.6:1 | 74,000 | 4.6 | 96.4 |

### Example 3

Apparatus, reactants and procedure similar to those described in example 1 were used in this example except xylene was used to dilute the silicon MQ resin to 50% (w/w) instead of hexamethyldisiloxane and the second liquid contained an acetate salt. Samples of the silicon resin, before and after treatment, were analyzed by Ion Chromatography (IC) and indicated that over 92% of all ionic species were removed from the silicon resin.

1. A process for preparing a silicone resin comprising:
I) polymerizing an alkali metal silicate in an acidic aqueous medium to form a silica hydrosol,
II) reacting the silica hydrosol with an organosilicon capping compound in a mixture containing an organic or siloxane solvent to form a silicone resin,
III) further processing the organic phase containing the silicone resin to remove an impurity by;
i) flowing a first liquid through a fiber bundle comprising a plurality of fibers extending lengthwise in a conduit, wherein the bundle has an upstream end and a downstream end, and the first liquid flows in a direction from the upstream end of the bundle to the downstream end; and
ii) while continuing (i), flowing a second liquid comprising the organic phase containing the silicone resin and an impurity through the fiber bundle in a direction from the upstream end of the bundle to the downstream end of the bundle to effect transfer of at least a portion of the impurity from the second liquid to the first liquid,
wherein the first liquid and the second liquid are substantially immiscible.

2. The process of claim 1 wherein the alkali metal silicate is sodium silicate.

3. The process of claim 1 wherein the acidic aqueous medium has a pH≦2.

4. The process of claim 1 wherein the acidic aqueous medium comprises hydrochloric acid.

5. The process of claim 1 where the organosilicon capping compound has the formula R¹ₙSiX₍₄₋ₙ₎ wherein
R¹ is independently a C₁-C₂₀ hydrocarbyl group or hydrogen,
X is a halogen atom, —OR², or —OSiR¹₃,
where R² is a C₁-C₆ alkyl group or hydrogen,
n is 1, 2, or 3.

6. The process of claim 1 wherein the organosilicon capping compound is
is trimethylchlorosilane, hexamethyldisiloxane, or a mixture thereof.

7. The process of claim 1 wherein the first liquid in step i) comprises water.

8. The process of claim 1 wherein the second liquid comprises an aromatic solvent.

9. The process of claim 1 wherein the second liquid comprises hexamethyldisiloxane.

10. The process of claim 1 where the impurity removed is hydrogen chloride.

11. The process of claim 10 wherein greater than 95% of the hydrogen chloride is removed from the second liquid.

12. (canceled)

13. The process of claim 1 wherein the silicone resin is a silicone MQ resin having a M/Q ratio varying from 0.5 to 1.5, a molecular weight (M_{w}) ranging from 10,000 to 30,000 g/mole, and a silanol (SiOH) content ranging from 0.5 wt % to 10.0 wt %.

14. The process of claim 13 wherein the silicone MQ resin has a hydrogen chloride content that is less than 1 wt %.

15. The process of claim 1 wherein the mixture from step II is allowed to separate into an aqueous phase and an organic phase containing the silicone resin.
